(19) United States
(12) Patent Application Publication
(10) Pub. No.: US 2025/0222411 A1
(43) Pub. Date: Jul. 10, 2025

(54) Industrial Scale Manufacturing Carbon Nanotubes Supported Reverse Osmotic Desalination Membrane

(71) Applicant: Atom H2O, LLC, Escondido, CA (US)

(72) Inventor: Huaping Li, Los Angeles, CA (US)

(73) Assignee: Atom H2O, LLC, Escondido, CA (US)

(21) Appl. No.: 19/014,113

(22) Filed: Jan. 8, 2025

Related U.S. Application Data
(60) Provisional application No. 63/618,480, filed on Jan. 8, 2024.

(51) Int. Cl. B01D 71/02; B01D 61/02; B01D 69/10; B01D 71/56; B01D 71/68; C02F 1/44; C02F 103/08

(52) U.S. Cl. CPC B01D 71/0212; B01D 61/025; B01D 69/107; B01D 71/56; B01D 71/68; C02F 1/441; C02F 2103/08

(57) ABSTRACT

Systems for manufacturing reverse osmotic desalination membranes are described. The system is for the industrial scale manufacturing of carbon nanotubes supported reverse osmotic desalination membranes. The system overcomes several technological challenges and develops new membranes, improving aspects of membrane manufacturing and performance.

### CROSS REFERENCE TO RELATED APPLICATIONS

The current application claims the benefit of and priority under 35 U.S.C. 119(e) to U.S. Provisional Patent Application No. 63/618,480 filed Jan. 8, 2024, the disclosure of which is incorporated herein by reference in its entirety.

### FIELD OF THE INVENTION

This application generally refers to systems for desalination. More specifically, this application relates to reverse osmotic desalination membranes, carbon nanotubes supported membranes, desalination technologies, and various aspects of their manufacture.

### BACKGROUND

Membranes are used in a wide variety of applications, including water desalination, water demineralization, gas separation dialysis, protection against chemicals, and as “breathable” materials.

Desalination is a process that removes mineral components, primarily salts, from saline water. Desalination technologies are often employed to create alternative water sources such as potable water suitable for human consumption, irrigation, and industrial uses. Desalination typically produces water from sources other than conventional surface and underground freshwater. Desalination water sources typically include seawater, brackish water, and wastewater sources. Desalination has the potential to generate large quantities of potable water, but it is energy-intensive process. In many applications the practicality for commercialization of desalination process as potable water source is constrained by the amount of energy required for operation. In most applications desalinating water is more expensive than obtaining fresh water from surface or groundwater, recycling water, and/or conserving water. In most applications, the desalination processes typically employ thermal methods, such as distillation, or membrane-based methods, such as reverse osmosis. Common desalination technologies and processes include reverse osmosis (RO), multi-stage flash (MSF), multiple-effect distillation (MED), electrodialysis (ED), vapor compression distillation (VCD), and micro, ultra, and nanofiltration (MF, UF, NF respectively).

Reverse osmosis (RO) is a membrane desalination process that reverses the osmotic flow through a semi-permeable membrane by utilizing a pressure differential across the membrane. The required pressure and associated energy for desalination often depend on the water's mineral content and the semi-permeable membrane's water-permeation characteristics. Extensive research has been conducted to develop new membranes and overcome technological challenges and improve efficiency. However, challenges remain in various aspects of membrane manufacturing and performance.

### SUMMARY OF THE INVENTION

Systems and methods in accordance with some embodiments of the invention are directed to reverse osmotic desalination membranes.

Many embodiments of the disclosure are directed to a method of manufacturing a multilayer membrane comprising, depositing a plurality of material layers upon a substrate comprising a first material; wherein the substrate is contained within a voluminous vessel configured for sequentially filling and draining the vessel with a plurality of solutions; sequentially filling the vessel with the plurality of solutions; sequentially draining the vessel with the plurality of solutions; holding each of the plurality of solutions within the vessel for a solution dwell time; wherein a first solution is a mixture comprising at least a second material suspended within the first solution that is configured to settle out of the mixture depositing the second material upon the substrate from the settling of the second material suspended in the first solution over a first solution dwell time; reacting a second solution and a third solution at an interface; wherein the second solution and the third solution form a bilayer interface and a polymerization reaction occurs at the bilayer interface forming a third material at the interface over a reaction dwell time; and wherein draining the second solution from the vessel after the reaction dwell time deposits the third material upon the substrate.

In many embodiments, the first material is polyethersulfone.

In many embodiments, the second material is high-pressure carbon monoxide single-walled carbon nanotubes.

In many embodiments, the third material is polyamide.

In many embodiments, the first solution is a mixture of a high-pressure carbon monoxide single-walled carbon nanotube powder and an aqueous solution.

In many embodiments, the aqueous solution includes Sodium Dodecyl Sulfate.

In many embodiments, the second solution is a m-phenylenediamine aqueous solution.

In many embodiments, the third solutions solution is a trimesoyl chloride hexane solution.

In many embodiments, the mixture is configured so that a significant portion of the second material settles on the substrate during the first solution dwell time and the first solution is drained after the first solution dwell time.

In many embodiments, the second solution and the third solution are each configured so that a reaction occurs at the bilayer interface during the reaction dwell time and the second solution is drained after the reaction dwell time.

In many embodiments, an approximately 10 nm nanofilm forms at the bilayer interface.

Many embodiments of the disclosure are directed to a membrane comprising a plurality of layers configured in a multi-layer structure; wherein the plurality of layers include a first material, a second material, and high-pressure carbon monoxide single-walled carbon nanotubes; wherein one of the plurality of layers is a substrate layer comprising the first material and configured to bond to a subsequent layer; wherein at least one of the plurality of layers consists of a network high-pressure carbon monoxide single-walled carbon nanotubes; and wherein each of the plurality of layers is configured such that a reverse osmosis process can be performed through the membrane.

In many embodiments, the first material is polyethersulfone, the second material is polyamide.

In many embodiments, the high-pressure carbon monoxide single-walled carbon nanotubes have a diameter from approximately 0.6 nm to 1.2 nm.

In many embodiments, the network of high-pressure carbon monoxide single-walled carbon nanotubes is configured for at least one of: reduced surface roughness of at least one of the plurality of layers, reduced area of pores of at least one of the plurality of layers, and support at least one of the plurality of layers.

In many embodiments, the reverse osmosis process is configured for over 98% salt rejection at under 250 psi.

Many embodiments of the disclosure are directed to a device comprising at least one membrane comprising a network of high-pressure carbon monoxide single-walled carbon nanotubes and a multi-layer structure consisting of layers of at least a first material, a second material, and a third material and the membrane is configured such that a reverse osmosis process can be performed through the membrane.

In many embodiments, the first material is polyethersulfone, the second material is high-pressure carbon monoxide single-walled carbon nanotubes and the third material is polyamide.

In many embodiments, one of the plurality of layers is a substrate layer configured to receive the network of high-pressure carbon monoxide single-walled carbon nanotubes, and the network of high-pressure carbon monoxide single-walled carbon nanotubes is configured to provide support for a subsequent layer.

In many embodiments, the reverse osmosis process is configured for over 98% salt rejection at under 250 psi.

Many embodiments of the disclosure are directed to a method of manufacturing a device comprising, depositing a plurality of material layers upon a substrate comprising of a first material; and sequentially exposing the substrate to a plurality of fluids; wherein exposing the substrate to a plurality of fluids deposits material layers upon the substrate; wherein at least one material layer is formed from a settling of a second material from a first fluid; and at least one material layer is formed from a polymerization reaction at a bilayer interface of at least two fluids and the bilayer interfacial polymerization layer is brought into contact with an other material layer.

In many embodiments, the first material is polyethersulfone.

In many embodiments, the first fluid is a mixture of a high-pressure carbon monoxide conversion single-walled carbon nanotube powder and an aqueous solution.

In many embodiments, the aqueous solution is Sodium Dodecyl Sulfate.

In many embodiments, the plurality of fluids includes at least a trimesoyl chloride hexane solution and an m-phenylenediamine aqueous solution.

In many embodiments, the bilayer interfacial polymerization reaction occurs between the trimesoyl chloride hexane solution and the m-phenylenediamine aqueous solution.

In many embodiments, the at least one material layer formed from the polymerization reaction is brought into contact with the other material layer by draining at least one of the plurality of fluids, depositing the interface layer onto the other material layer.

In many embodiments, the at least one layer formed from a polymerization reaction is brought into contact with the other material layer by passing the other material layer through the interface.

Many embodiments of the disclosure are directed to an apparatus configured for the manufacturing of multi-layer membrane devices comprising, a voluminous vessel configured: to contain, fill, and discharge fluids; with a plurality of inlets, at least one outlet; and with a planer interior surface for a substrate to be affixed upon.

In many embodiments, the plurality of inlets are further configured to fill the vessel from at least a first, a second, and a third point distal from the planer interior surface, and at least one point is located proximal to a bilayer interface formed from filling the vessel with at least two fluids.

In many embodiments, the outlet is configured for the draining of the fluid proximal to the planer interior surface.

In many embodiments, at least one inlet is further configured with a plurality of orifices such that the plurality of orifices discharge fluid in a plane distal from the planer interior surface

In many embodiments, the plurality of orifices are configured contiguously on an inner surface of the vessel.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIG. 1 illustrates a flow chart of an exemplary method of preparing a solution of of High Pressure Carbon Monoxide (HiPCO) Single-Walled Carbon Nanotubes (SWCNTs) in accordance with some embodiments.

FIG. 2 illustrates the Vis-NIR absorption spectrum of raw HiPCO SWCNTs in an SDS aqueous solution and the normalized absorbance of washed-down HiPCO SWCNTs in accordance with some embodiments.

FIG. 3 illustrates the processes of manufacturing Polyamide (PA) nanofilm on HiPCO SWCNTs covered PES membranes according to various embodiments.

FIGS. 4A through 4C illustrate a fabrication tray, tri-layer desalination membrane, and rolled spiral wound element in accordance with an exemplary embodiment.

FIG. 5 illustrates scanning electron microscope (SEM) images of polyethersulfone (PES) films with sputtered gold nanoparticles and HIPCO SWCNTs covered PES films in accordance with some exemplary embodiments.

FIG. 6 illustrates SEM images of PA/SWCNTs/PES tri-layer desalinization membranes with sputtered gold nanoparticles in accordance with some exemplary embodiments.

FIG. 7A through FIG. 7D illustrate SEM images of PA/SWCNTs/PES tri-layer desalinization membranes cut with an E-beam in accordance with some exemplary embodiments.

FIG. 8 illustrates a desalination test of NaCl salt rejection in accordance with an exemplary embodiment.

FIG. 9 illustrates a desalination test of MgSO₄ salt rejection in accordance with various exemplary embodiments.

### DETAILED DESCRIPTION OF THE INVENTION

Polyamide (PA) reverse osmosis (RO) spiral-wound membranes play an essential role in many membrane applications. PA RO membranes are crucial for various types of membrane, such as those used in ultrafiltration, nanofiltration, reverse osmosis, and forward osmosis. PA RO spiral-wound membranes are frequently used to purify and remove salt from seawater, wastewater, and surface water. In many applications, the purification process produces new alternative sources of water for human consumption, irrigation, and other industrial uses in areas where traditional water supplies are limited or nonexistent. In many scenarios when access to traditional water supplies is limited, PA RO membranes are often favored by industry because they operate at lower pressures compared to other RO membranes. In many such applications, lower pressure operation results in lower energy consumption and, consequently, lower operating costs.

For desalination applications, PA RO membranes are often manufactured via sequential layer-by-layer interfacial polymerization. The sequential layer-by-layer interfacial polymerization manufacturing process frequently utilizes a porous support. This manufacturing technique results in a “crumpled” PO layer. Which in typical manufacturing results in a PO layer with a thickness in the range of 50 nm to 200 nm between the “crumpled” layer's crest and trough which are the relative high points and low points of the crumpled layer. The crumpled features result from the folding and stacking of the PA layer. However, the functioning PA film layer is smooth and often around 10 nm thick.

In many applications, membranes are prone to bio-fouling and clogging such as due to the build-up of microorganisms in or on the membrane layers. A clogged membrane often reduces the efficiency of the membrane, which in desalination applications can deteriorate and ultimately destroy the desalination capacity of the membrane. Therefore, chlorine is typically added to disinfect desalination sources upstream of the membrane to inhibit and control the buildup of microorganisms and prevent water-borne diseases. However, chlorine can also degrade PA RO membranes, and thus, employing chlorine is an imperfect solution.

Integrating nanoscale materials, such as carbon nanotubes, graphene, and carbon nitride, into the membranes can enhance the chlorine resistance of PA RO membranes. Accordingly, using multi-walled carbon nanotubes (MWCNTs) PA composite can result in high-performance RO membranes with a higher flow flux that exhibit anti-scaling, antifouling, and chlorine resistance properties. Additional performance improvements can be achieved by fabricating MWCNTs via layer-by-layer interfacial polymerization and by incorporating MWCNTs of greater thicknesses. Such as an approximately 100 nm thickness that can be achieved with layer-by-layer interfacial polymerization, even further performance enhancements can be achieved when utilizing MWCNTs nanocomposite in conjunction with MWCNTs supports such as combinations of MWCNTs polypropene nanocomposites and MWCNTs polysulfone supports. The inclusion of MWCNTs in membranes can lead to improved water transport through the membrane as a result of greater water transport through the inner pores or inter-tubes of the aligned MWCNTs. When single-walled carbon nanotubes (SWCNTs) are embedded in a matrix, the water flow can be up to 1000 times higher than would be predicted by the Hagen-Poiseuille flow, such as when SWCNTs, ranging from 0.67 nm to 1.27 nm in diameter, are embedded in a polysulfone matrix. A comparable result can be achieved by utilizing aligned double-walled carbon nanotubes such as aligned double-walled carbon nanotubes encapsulated with chemical vapor deposited SiNx films.

### Embodiments

The disclosure includes several embodiments directed towards the use of high-pressure carbon monoxide conversion (HIPCO) single-walled carbon nanotubes (SWCNTs) networks in membranes. Various embodiments of the membrane incorporate carbon nanotubes, providing anti-scaling, antifouling, and fluorine resistance. In many embodiments, a blend of HIPCO SWCNTs with open ends and polymers like PES or PA can be directly applied to each other, which in many such embodiments can reduce the cost of fabricating the membrane. Similarly, devices that utilize the membranes, such as spiral wound elements, can reduce the number of steps required for the element fabrication. Accordingly, manufacturing membranes and desalination elements in accordance with many embodiments can result in material savings compared to membranes and elements more commonly used in industry, such as traditional membranes made from 50-100 nm crumpled PA film and membranes formed through layer-by-layer interfacial polymerization. Additionally manufacturing membranes and elements manufactured in accordance with many embodiments can produce membranes comprising sub-10 nm PA nanofilms. Many membranes and elements manufactured in accordance with the disclosure can result in more permeate at lower pressures, which can result in reduced operating costs compared to traditional membranes.

### Preparation of Solution

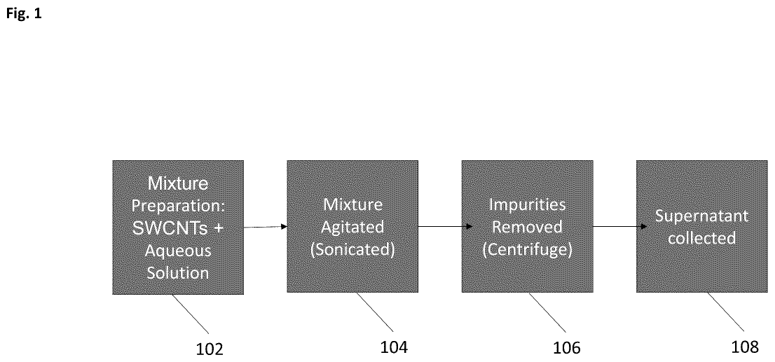

FIG. 1 illustrates a flow chart of an exemplary method of preparing a solution of HiPCO SWCNTs in accordance with some embodiments. At step 102, a mixture is prepared from raw HiPCO SWCNTs powder and an aqueous solution. At step 104, the mixture is agitated. In many embodiments, sonication is employed to agitate the mixture and homogenize the mixture. At step 106, impurities are removed from the mixture such as any residue catalyst and large nanotube bundles. In many embodiments, the impurities are removed via a centrifuge. At step 108, the resultant supernatant is collected. In many embodiments, the resultant supernatant is able to be utilized as a starting solution for further processing and membrane fabrication such as a starting solution for gel chromatography.

### Exemplary Embodiments

In an exemplary HiPCO SWCNTs solutions preparation that was prepared in accordance with the method illustrated by FIG. 1, a mixture of HIPCO SWCNTs is prepared from 100 mg of HIPCO SWCNTs raw powder mixed with 100 ml of 2% Sodium Dodecyl Sulfate (SDS, 99+% pure) aqueous solution forming a mixture (step 102). The mixture is then agitated (step 104) via sonication by Cole Parmer, 20 W ultrasonic processor equipped with a 0.5-inch Ti flat tip for 20 hours under continuous water cooling. The residue catalyst, large nanotube bundles, and other impurities are removed (step 106) via ultracentrifugation using a Beckman TL-100 ultracentrifuge equipped with a (TLS-55) rotor. The top 90% of the supernatant is then collected (step 108) to be utilized as the starting solution for gel chromatography.

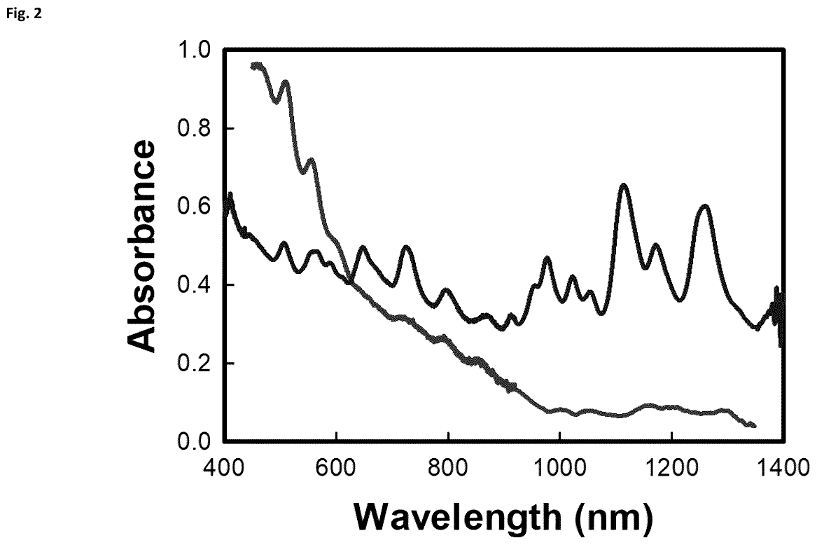

FIG. 2 illustrates exemplary Near-Infrared-Visible (NIR-Vis) absorption spectrum data for the exemplary solution described above. FIG. 2 shows NIR-Vis absorption spectrum of 1 weight % raw HiPCO SWCNTs in 2% SDS aqueous solution and the normalized absorbance of HIPCO SWCNTs washed down from a gel column using 2% SDS aqueous solution. The NIR-Vis absorption spectrum of the solution was measured using an NS3 Nanospectralyzer. As illustrated in FIG. 2 the solution exhibits the characteristic features of S11 (830-1400 nm), S22 (600-800 nm), and M11 (400-645 nm) Van Hove singularities of small diameter SWCNTs. The Visible-Near Infrared absorption spectrum of the unabsorbed HiPCO SWCNTs is dominated by M11 (400-645 nm) Van Hove Singularities of SWCNTs, as shown in FIG. 2. The absorption peaks indicate that the diameters of the HiPCO SWCNTs range from 0.6 nm to 1.2 nm. The exemplary supernatant HiPCO SWCNTs solution was loaded onto in-house packed columns with allyl dextran-based gel beads, and the unabsorbed HiPCO SWCNTs were washed with 2% SDS solution and used in the fabrication of desalination membranes in accordance with many embodiments.

In accordance with many embodiments networks with diameters of the HiPCO SWCNTs in the range of approximately 0.6 nm to 1.2 nm are more effective at rejecting salt compared to other types of SWCNTs, such as arc-discharged SWCNTs, double-walled carbon nanotubes, and multi-walled carbon nanotubes. In many embodiments, the networks have an average length of approximately 1 μm. In many embodiments, the networks have a diameter range from 0.6 nm to 1.2 nm. In many embodiments, the networks are utilized as a nanomaterial support. Many such embodiments result in smooth nanofilms. In many embodiments, the smooth nanofilms are sub 10 nm. In many embodiments, the smooth nanofilms are polyamide nanofilms. In accordance with many embodiments, the networks are fabricated via organic-aqueous bilayer interfacial polymerization. In many embodiments, the networks are fabricated on porous polyethersulfone (PES) substrates.

In accordance with many embodiments, a HiPCO SWCNTs network is deposited on PES substrates using surfactant displacement. In some such embodiments, the surfactant displacement is from a 2% sodium dodecyl sulfate dispersed aqueous solution. In many embodiments the HiPCO SWCNTs network is characterized using a scanning electron microscope (SEM) to reduce the pore sizes and surface roughness of the PES substrates. In many embodiments, interconnected HiPCO SWCNTs networks serve as mechanically strong binders between PES and PA. In many such embodiments, the networks function as a binder as a result of TT-conjugated surfaces that incline to bind the phenyl ring and amide of PA. In many embodiments, these factors enhance the performance of PA, SWCNTs, and PES desalination membranes. In various embodiments, the membranes are utilized in flat sheet desalination elements to enhance performance. In many embodiments, the membranes are utilized to enhance performance in rolled desalination elements. In numerous embodiments, the membranes are utilized to enhance spiral wound elements.

### Manufacturing Process

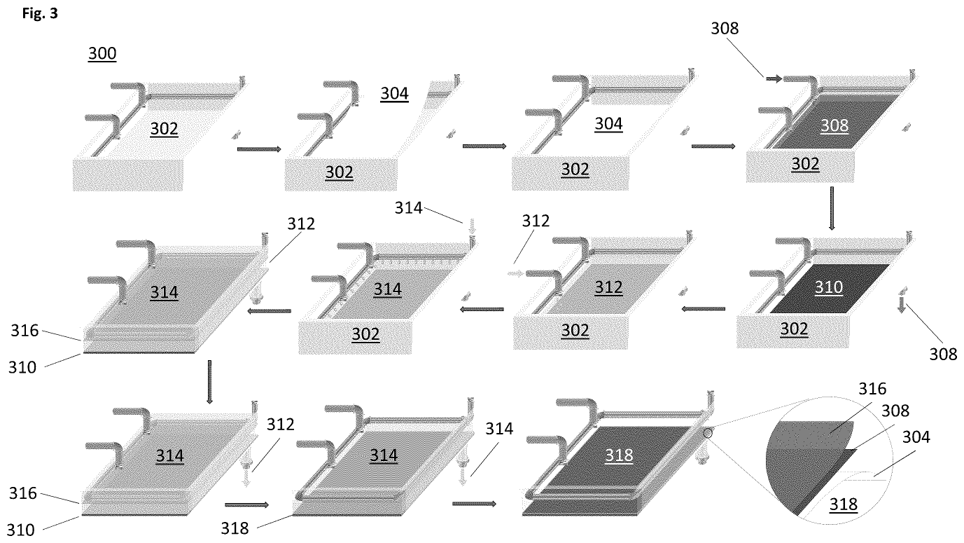

FIG. 3 illustrates an exemplary manufacturing process 300 for producing PA nanofilm on HiPCO SWCNTs covered PES membranes according to various embodiments. In accordance with the exemplary manufacturing process 300 a substrate tray 302 is prepared. Inside the tray 302 a PES substrate 304 is positioned; the PES substrate 304 is laid flat within the tray 300; prepared HiPCO SWCNTs stocked solution 308, such as the HiPCO SWCNTs solution described above and illustrated in FIG. 1 is injected into the tray 302 fully covering and submerging the PES substrate 304 in the tray 302; after a settling period the HiPCO SWCNTs solution 308 is then discharged from the tray 302 and the HiPCO SWCNTs covered PES substrate 310 remains within the tray 302; subsequently a MPD (3%) solution 312 is injected to fully cover and submerge the HiPCO SWCNTs covered PES substrate 310 in the tray 302; a trimesoyl chloride TMC hexane (0.15%) solution 314 is then slowly injected above the surface of the MPD aqueous solution 312; fully covering the MPD aqueous solution 312 layer with a layer of a TMC hexane solution 314; The MPD layer 312 and TMC layer 314 undergo polymerization at the bilayer interface forming an approximately 10 nm smooth PA nanofilm 316; After a holding periods to secure high quality PA nanolayer polymerization the MPD aqueous solution 312 is slowly discharged from the bottom of the tray 302; the draining of the MPD aqueous solution 312 results in the bilayer interface and polymerized PA nanofilm 316 lowering, with the PA nanofilm 316 depositing on to the HiPCO SWCNTs covered PES substrate 310; The TMC hexane solution 314 is subsequently drained from the bottom of tray 302; the tri-layer membrane 318 comprising a structure of a smooth PA film layer 316, a HiPCO SWCTs network layer 308, and PES base layer 304 remains within the drained tray 302.

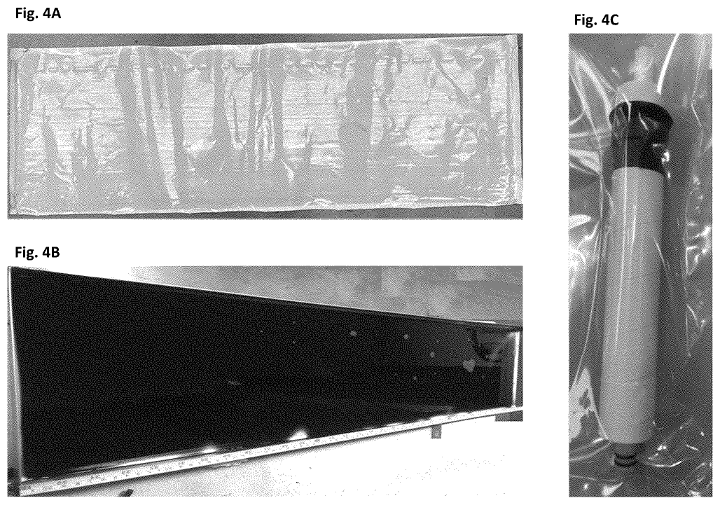

FIGS. 4A through 4C illustrate an exemplary embodiment of a PA, SWCNTs, PES tri-layer desalination membrane (FIG. 4A), fabrication tray (FIG. 4B), and rolled spiral wound element (FIG. 4C) fabricated from a tri-layer desalination membrane manufactured in accordance with the processes illustrated in FIG. 3.

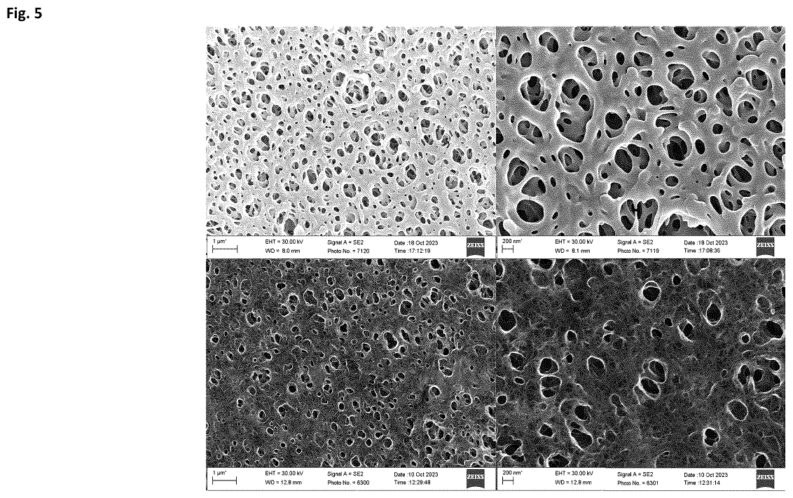

Many embodiments of the disclosure are directed to smooth sub-10 nm PA nanofilm on HiPCO SWCNTs covered PES substrates. Many such embodiments are manufactured via an aqueous-organic bilayer interfacial polymerization, such as described above and illustrated in FIG. 3. FIG. 5 illustrates exemplary Scanning Electron Microscopy (SEM) characterization images of samples prepared in accordance with many embodiments of the disclosure. The SEM images show PES films with sputtered gold nanoparticles (top) and HiPCO SWCNTs covered PES films (bottom). The contrasting SEM characterization images illustrate the networks of HiPCO SWCNTs covering the surface of the PES film and reducing the pore area and surface roughness, of the film and thereby providing high-performance support for subsequent layers such as a flat Polyamide (PA) nanofilm.

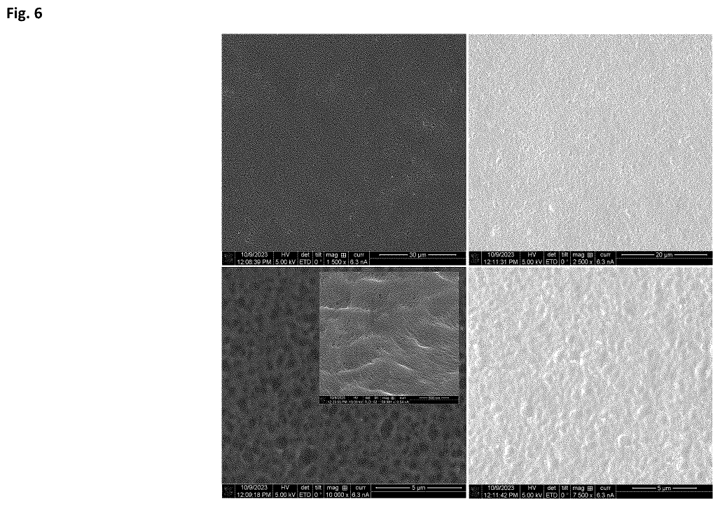

FIG. 6 illustrates exemplary tri-layer membrane samples prepared in accordance with many embodiments of the disclosure. The exemplary SEM characterization images show tri-layer PA, SWCNTs, PES desalination membranes directly imaged (left) and imaged with sputtered gold nanoparticles (right).

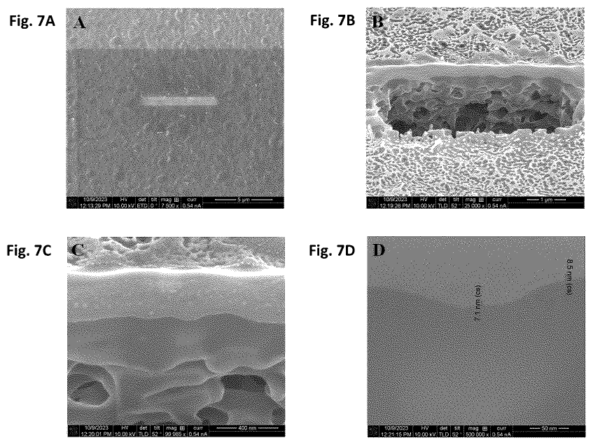

FIGS. 7A through 7D, Illustrate SEM characterization images of an exemplary tri-layer PA, SWCNTs, PES membrane prepared in accordance with many embodiments of the disclosure. FIG. 7A. Illustrates an exemplary tri-layer PA, SWCNTs, PES membrane with sputtered gold nanoparticles with and a platinum bar deposited on the sample; FIG. 7B illustrates a E-beam cut portion the PA, SWCNTs, PES membrane; FIG. 7C illustrates a zoomed in image of the cross section of E-beam cut area; FIG. 7D illustrates a further zoom-in image of the cross section of E-beam cut area with labelling for the PA layer thickness.

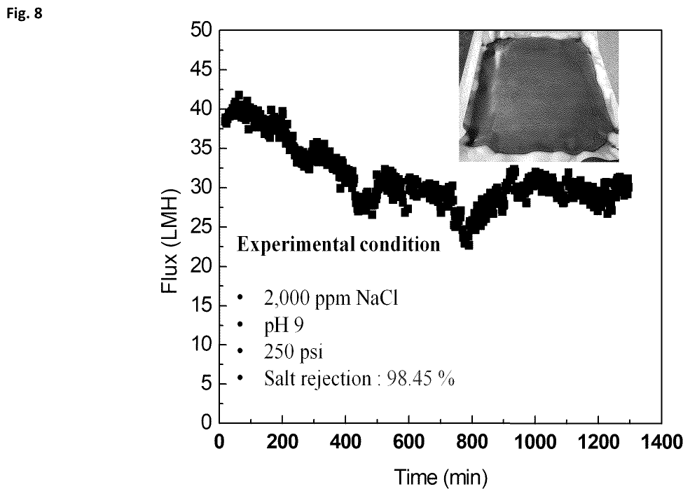

Various exemplary embodiments prepared in accordance with the disclosure have demonstrated that PA, SWCNTs, and PES membranes utilized in desalinization applications can exceed a 98% salt rejection rate. FIG. 8 illustrates an exemplary tri-layer PA, SWCNTs, PES membrane embodiment, and salt rejection data for the embodiment. A desalination test on flat (200 mm×200 mm) PA, SWCNTs, PES membrane was performed. The exemplary embodiment was fed with 2,000 ppm NaCl at a pH of 9, pressure under 250 psi, and water flux of 30 LMH, resulting in a 98.45% salt rejection.

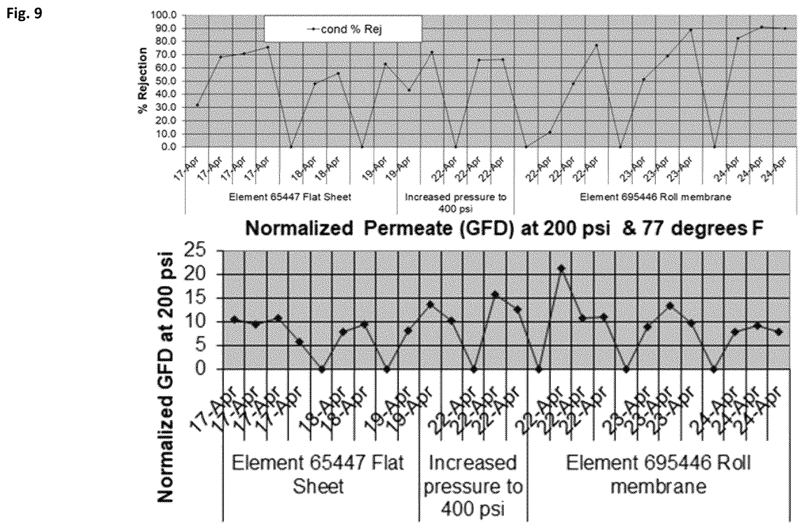

FIG. 9 illustrates exemplary desalination data for rolled spiral wound elements employing a tri-layer PA, SWCNTs, PES membrane embodiment. Rolled spiral wound elements fabricated from 508 mm×915 mm PA, SWCNTs, and PES membranes were tested for desalination by feeding them 2,000 ppm MgSO₄ at a pH range of 9 to 11 and pressure under 200 psi. The normalized permeate of the spiral wound element was around 10 GFD (17.01 LMH) with a 90% salt rejection.

### Exemplary Applications

Various embodiments of the membrane incorporate carbon nanotubes, providing anti-scaling, antifouling, and fluorine resistance. In such embodiments, a blend of HIPCO SWCNTs, such as acid-treated SWCNTs with open ends and polymers like PES or PA, is directly applied (for instance, on Tricot) which can reduce the cost of fabricating the spiral wound element by reducing the number of steps required for the element fabrication.

Manufacturing membrane and desalination elements in accordance with the disclosure expands the selection of membranes available to include flat PA nanofilms with a thickness of less than 10 nm, formed through aqueous-organic bilayer interfacial polymerization. The present manufacturing technique can result in material savings compared to commonly used industry membranes, such as those made from 50-100 nm crumpled PA film formed through layer-by-layer interfacial polymerization.

Furthermore, the present manufacturing technique of this sub-10 nm PA nanofilm results in higher permeate at lower pressures which can consequently reduce operating costs in the industry compared to traditional membranes.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A method of manufacturing a multilayer membrane comprising,
depositing a plurality of material layers upon a substrate comprised of a first material;
wherein the substrate is contained within a voluminous vessel configured for sequentially filling and draining the vessel with a plurality of solutions;
sequentially filling the vessel with the plurality of solutions;
sequentially draining the vessel with the plurality of solutions;
holding each of the plurality of solutions within the vessel for a solution dwell time;
wherein a first solution is a mixture comprising at least a second material suspended within the first solution that is configured to settle out of the mixture depositing the second material upon the substrate from the settling of the second material suspended in the first solution over a first solution dwell time;
reacting a second solution and a third solution at an interface;
wherein the second solution and the third solution form a bilayer interface and a polymerization reaction occurs at the bilayer interface forming a third material at the interface over a reaction dwell time; and
wherein draining the second solution from the vessel after the reaction dwell time deposits the third material upon the substrate.

2. The method of claim 1, wherein the first material is polyethersulfone.

3. The method of claim 1, wherein the second material is high-pressure carbon monoxide single-walled carbon nanotubes.

4. The method of claim 1, wherein the third material is polyamide.

5. The method of claim 1, wherein the first solution is a mixture of a high-pressure carbon monoxide single-walled carbon nanotube powder and an aqueous solution.

6. The method of claim 5, wherein the aqueous solution comprises Sodium Dodecyl Sulfate.

7. The method of claim 1, wherein the second solution is a m-phenylenediamine aqueous solution.

8. The method of claim 1, wherein the third solutions solution is a trimesoyl chloride hexane solution.

9. The method of claim 1, wherein the mixture is configured so that a significant portion of the second material settles on the substrate during the first solution dwell time and the first solution is drained after the first solution dwell time.

10. The method of claim 1, wherein the second solution and the third solution are each configured so that a reaction occurs at the bilayer interface during the reaction dwell time and the second solution is drained after the reaction dwell time.

11. The method of claim 1, wherein an approximately 10 nm nanofilm forms at the bilayer interface.

12. A membrane comprising,
a plurality of layers configured in a multi-layer structure;
wherein the plurality of layers comprise a first material, a second material, and high-pressure carbon monoxide single-walled carbon nanotubes;
wherein one of the plurality of layers is a substrate layer comprising the first material and configured to bond to a subsequent layer;
wherein at least one of the plurality of layers consists of a network high-pressure carbon monoxide single-walled carbon nanotubes; and
wherein each of the plurality of layers is configured such that a reverse osmosis process can be performed through the membrane.

13. The membrane of claim 12, wherein the first material is polyethersulfone, the second material is polyamide.

14. The membrane of claim 12, wherein the high-pressure carbon monoxide single-walled carbon nanotubes have a diameter from approximately 0.6 nm to 1.2 nm.

15. The membrane of claim 12, wherein the network of high-pressure carbon monoxide single-walled carbon nanotubes is configured for at least one of: reduced surface roughness of at least one of the plurality of layers, reduced area of pores of at least one of the plurality of layers, and support at least one of the plurality of layers.

16. The membrane of claim 12, wherein the reverse osmosis process is configured for over 98% salt rejection at under 250 psi.

17. A device comprising,
at least one membrane comprising a network of high-pressure carbon monoxide single-walled carbon nanotubes and a multi-layer structure consisting of layers of at least a first material, a second material, and a third material and
the membrane is configured such that a reverse osmosis process can be performed through the membrane.

18. The device of claim 17, wherein the first material is polyethersulfone, the second material is high-pressure carbon monoxide single-walled carbon nanotubes and the third material is polyamide.

19. The device of claim 17, wherein one of the plurality of layers is a substrate layer configured to receive the network of high-pressure carbon monoxide single-walled carbon nanotubes, and the network of high-pressure carbon monoxide single-walled carbon nanotubes is configured to provide support for a subsequent layer.

20. The device of claim 17, wherein the reverse osmosis process is configured for over 98% salt rejection at under 250 psi.

21. A method of manufacturing a device comprising,
depositing a plurality of material layers upon a substrate comprised of a first material; and
sequentially exposing the substrate to a plurality of fluids;
wherein exposing the substrate to a plurality of fluids deposits material layers upon the substrate;
wherein at least one material layer is formed from a settling of a second material from a first fluid; and
at least one material layer is formed from a polymerization reaction at a bilayer interface of at least two fluids and the bilayer interfacial polymerization layer is brought into contact with an other material layer.

22. The method of claim 21, wherein the first material is polyethersulfone.

23. The method of claim 21, wherein the first fluid is a mixture of a high-pressure carbon monoxide conversion single-walled carbon nanotube powder and an aqueous solution.

24. The method of claim 23, wherein the aqueous solution is Sodium Dodecyl Sulfate.

25. The method of claim 21, wherein the plurality of fluids comprises at least a trimesoyl chloride hexane solution and an m-phenylenediamine aqueous solution.

26. The method of claim 25, wherein the bilayer interfacial polymerization reaction occurs between the trimesoyl chloride hexane solution and the m-phenylenediamine aqueous solution.

27. The method of claim 21, wherein the at least one material layer formed from the polymerization reaction is brought into contact with the other material layer by draining at least one of the plurality of fluids, depositing the interface layer onto the other material layer.

28. The method of claim 21, wherein the at least one layer formed from a polymerization reaction is brought into contact with the other material layer by passing the other material layer through the interface.

29. An apparatus configured for the manufacturing of multi-layer membrane devices comprising, a voluminous vessel configured:
to contain, fill, and discharge fluids;
with a plurality of inlets, at least one outlet; and
with a planer interior surface for a substrate to be affixed upon.

30. The apparatus of claim 29, wherein the plurality of inlets are further configured to fill the vessel from at least a first, a second, and a third point distal from the planer interior surface, and at least one point is located proximal to a bilayer interface formed from filling the vessel with at least two fluids.

31. The apparatus of claim 29, wherein the outlet is configured for the draining of the fluid proximal to the planer interior surface.

32. The apparatus of claim 30, wherein at least one inlet is further configured with a plurality of orifices such that the plurality of orifices discharge fluid in a plane distal from the planer interior surface

33. The apparatus of claim 32, wherein the plurality of orifices are configured contiguously on an inner surface of the vessel.
